(19) United States
(12) Patent Application Publication
(10) Pub. No.: US 2026/0280145 A1
(43) Pub. Date: Sep. 17, 2026

(54) TIGHTLY COUPLED DIPOLE ARRAY ANTENNAS

(71) Applicant: TEKNOLOGIAN TUTKIMUSKESKUS VTT OY, Espoo (FI)

(72) Inventor: Matti SOMERSALO, Espoo (FI)

(21) Appl. No.: 19/167,237

(22) PCT Filed: Mar. 19, 2024
(86) PCT No.: PCT/FI2024/050125

§ 371 Date: Sep. 19, 2025

(30) Foreign Application Priority Data
Mar. 20, 2023 (FI) 20235321

(51) Int. Cl. H01Q 21/06; H01Q 5/48; H01Q 21/08; H01Q 21/24

(52) U.S. Cl. CPC H01Q 21/062; H01Q 5/48; H01Q 21/08; H01Q 21/24

(57) ABSTRACT

The present invention relates to a polarized tightly coupled dipole antenna array comprising a plurality of rectangular unit cells. Each unit cell comprises a bottom sheet comprising a ground plane and at least two first half-dipole antenna elements. Dipole antenna elements of the antenna array are formed by two first half-dipole antenna elements of adjacent unit cells.

Each unit cell comprises a top sheet parallel to the bottom sheet. The top sheet comprises a coupling pattern at the center of the unit cell. The coupling pattern is configured to capacitively couple at least two adjacent dipole antenna elements. The coupling pattern is grounded by a connection line extending between the top sheet and ground provided at the bottom sheet.

The antenna array may be manufactured using printed circuit boards, flexible dielectric sheets, thermoformable dielectric sheets or a combination thereof.

### CROSS REFERENCE TO RELATED APPLICATIONS

This application is a continuation of PCT Application No. PCT/FI2024/050125, filed Mar. 19, 2024, which claims priority to Finnish Patent Application No. 20235321, filed Mar. 20, 2023, the entire contents of each of which are hereby incorporated by reference in its entirety.

### FIELD

The present invention relates to apparatuses, and manufacturing methods related to array antennas. More particularly, the present invention relates to tightly coupled dipole array (TCDA) antennas and manufacturing thereof.

### BACKGROUND

Tightly coupled dipoles (TCD) are known to have ultrawide bandwidths compared to conventional self-resonating antennas. An array of TCDs, referred to as a tightly coupled dipole array TCDA antenna, can be used for generating high-bandwidth antennas. A TCD requires neighbors on all sides to work properly. Thus, a TCDA antenna typically has some dummy TCD elements or dummy element terminations surrounding the actual active TCDA antenna structure.

### DESCRIPTION OF THE RELATED ART

Article “An active, ultra-wideband dual-polarized tightly coupled dipole subarray for satellite communication” by Li H, et al, published in International Journal of RF and Microwave Computer-Aided Engineering (2021) 31 (11) discloses a TCDA structure with a relatively complex design using dipoles printed on vertical PCB-faces.

US20120146869 A1 discloses a planar ultrawideband modular array antenna structure known as planar ultrawideband modular antenna (PUMA) array, in which dipole arms extending on two opposite sides of a laminate partially overlap during a distance for coupling. Structure of the PUMA array is complex, including several dielectric layers, element layers, an impedance matching layer, a low permittivity substrate and coaxial connectors or transmission lines.

US2005030246 A1 discloses a phased array antenna with capacitive coupling between adjacent dipoles. A monolithic flexible substrate is bent to form a “box” shape and feed lines are connected to each feed portion from the opposite side of the substrate.

US2012146872 A1 discloses an antenna radiating element and a method for constructing such antenna radiating element. Each dipole antenna is provided with a director, and interfering elements are provided to minimize coupling between parallel radiating elements.

US20210203085 A1 discloses a broadband antenna array with antenna cells having two feed posts formed of conductive material and a centrally located ground post. Feed posts are either freestanding metallic pins or posts or formed as an integral part of a monolithic card manufactured using a multilayer build process. A problem with known implementations of TCDA antennas is that their implementations are complex, require specific materials, and are therefore expensive.

### SUMMARY

An object is to provide a method and apparatus to solve the problem of simplifying mechanical design of TCDA antennas using low-cost materials and manufacturing methods. The objects of the present invention are achieved with an antenna array apparatus according to claim 1. Objects of the present invention are further achieved with manufacturing methods according to claim 16, 17, 18 or 19.

The preferred embodiments of the invention are disclosed in the dependent claims.

The present invention is based on the idea of implementing the TCDA antenna using a unit cell design that can be copied to form a rectangular grid, size of which is scalable to any size. The entire structure is designed to be manufactured using cheap materials. Metallized antenna elements, lines and coupling patterns can be printed on one or two sides of sheets. The antenna array may be manufactured using printed circuit boards, flexible dielectric sheets, thermoformable dielectric sheets or various combinations of these.

According to a first embodiment, a polarized tightly coupled dipole antenna array is provided, which comprises a plurality of rectangular unit cells (UC). Each UC comprises a bottom sheet comprising a ground plane, and two first half-dipole antenna elements. Each first half-dipole antenna element comprises an arm parallel to the bottom sheet and spaced from the bottom sheet, and an antenna feed line extending to the bottom sheet. Antenna feed lines of the two first half-dipole antenna elements extend between the bottom sheet and the respective arm in proximity of two opposite sides of the UC. Arms of the two first half-dipole antenna elements fed by said antenna feed lines extend from two opposite sides of the UC towards each other. Each first dipole antenna element of the antenna array with a first polarity are formed by two first half-dipole antenna elements of adjacent UCs. Each UC further comprises a top sheet parallel to the bottom sheet. The top sheet is made of dielectric material and comprises a coupling pattern at the center of the UC. The coupling pattern is on either face of the top sheet. The coupling pattern is configured to capacitively couple two dipole antenna elements. The coupling pattern is optionally grounded by a connection line extending between the top sheet and ground provided at the bottom sheet.

According to a second embodiment of the polarized tightly coupled dipole antenna array, each UC further comprises two second half-dipole antenna elements. Each second half-dipole antenna element comprises an arm parallel to the bottom sheet and spaced from the bottom sheet, and an antenna feed line extending to the bottom sheet. Arms of the first half-dipole antenna elements are orthogonal to arms of the second half-dipole antenna elements. Antenna feed lines of the two second half-dipole antenna elements extend between the bottom sheet and the respective arm in proximity of two opposite sides of the UC. Arms of the two second half-dipole antenna elements fed by said antenna feed lines extend from two opposite sides of the UC towards each other. Each second dipole antenna element of the antenna array with a second polarity is formed by two second half-dipole antenna element of adjacent UCs. The coupling pattern at the center of each UC is configured to capacitively couple two first dipole antenna elements and two second dipole antenna elements. The coupling pattern is optionally grounded by at least two connection lines extending between the top sheet and ground provided at the bottom sheet.

According to some embodiments, the connection lines are connected to the coupling pattern in proximity of arms of half-dipoles connected to RF feeds.

According to some embodiments, all half-dipoles, antenna feed lines, coupling pattens and connection lines are metallization printed on sheets of dielectric material.

According to some embodiments, the metallization is conductive ink, such as Ag-paste.

According to some embodiments, the antenna array is implemented with a plurality of printed circuit boards, PCB. The bottom sheet is a PCB, and the top sheet is a PCB. A plurality of first dipole antenna elements of the plurality of UCs is disposed on a first face of one or more first dipole array PCBs and a plurality of connection lines are disposed on the second face of the one or more first dipole array PCBs. In the second embodiment, a plurality of second dipole antenna elements of the plurality of UCs is disposed on a first face of one or more second dipole array PCBs and a plurality of connection lines are disposed on the second face of the one or more second dipole array PCBs. In the first embodiment, a plurality of second dipole array PCBs with no dipole antenna elements. The one or more of first dipole array PCBs and the one or more second dipole array PCBs are provided with dedicated slots for assembling the one or more of first dipole array PCBs and the one or more second dipole array PCBs in mutually crossed arrangement.

According to some embodiments, each portion of the first and the second dipole array PCB corresponding to an UC comprises an aligning tooth and a connecting tooth. Each connecting tooth is configured to be installed within a respective connecting slot in the top sheet, and each aligning tooth is configured to be installed within a respective aligning slot in the bottom sheet.

According to some embodiments, each connecting tooth is arranged on extension of a respective connection line, and wherein the extension of the connection line is configured to be connected to the coupling pattern in the top sheet.

According to another embodiment, the bottom sheet is a PCB, and antenna feed lines and arms of dipole antenna elements, connection lines and coupling patterns are disposed on two faces of a flexible or thermoformable top sheet. Antenna feed lines of the dipole antenna elements and connecting patterns are partially cut out from the top sheet, bent towards the bottom sheet and electrically coupled to respective RF feeds or ground provided at the bottom sheet.

According to a further embodiment, connection lines, and antenna feed lines of the dipole antenna elements are on a flexible or thermoformable bottom sheet, and arms of the dipole antenna elements, and coupling patterns are on a flexible or thermoformable top sheet. Antenna feed lines of the dipole antenna elements and connecting patterns are partially cut out from the bottom sheet, bent towards the top sheet and electrically coupled to respective arms and coupling pattern on the top sheet.

According to some embodiments, the flexible or thermoformable bottom sheet and the flexible or thermoformable top sheet are provided as two portions of a single flexible or thermoformable sheet. A bend portion is provided between the two portions for bending the flexible or thermoformable bottom sheet and the flexible or thermoformable top sheet parallel to each other.

According to some embodiments, at least one supporting sheet is sandwiched between the bottom sheet and the top sheet. The at least one supporting sheet is parallel to the top sheet and to the bottom sheet. The at least one supporting sheet is provided with slots for passing connection lines and antenna feed lines through the at least one supporting sheet.

According to some embodiments, two supporting sheets are sandwiched between the bottom sheet and the top sheet, and a spacer is provided between the two supporting sheets.

According to some embodiments, a 3D printed supporting structure is sandwiched between the top sheet and the bottom sheet, the supporting structure having slots for connection lines and antenna feeds.

According to some embodiments, the flexible top sheet is a polyethylene, polyimide, or polycarbonate membrane. According to some embodiments, the flexible bottom sheet is a polyethylene, polyimide, or polycarbonate membrane.

According to some manufacturing method embodiments, when manufacturing the antenna array using PCBs, the method comprises assembling the one or more first dipole array PCBs and the one or more second dipole array PCBs arranged into a rectangular grid on top of the bottom PCB. Locations of the first and second dipole array PCBs on the bottom PCB are determined by fitting alignment teeth at the bottom edge of the first and second dipole array PCBs into alignment slots on the bottom PCB. The method comprises electrically connecting antenna feed lines and connection lines on the dipole array PCBs with the bottom PCB. The method comprises assembling a top PCB on top of the grid. Location of the top PCB on the grid is determined by fitting connecting teeth at the top edge of the first and second dipole array PCBs. The method further comprises electrically connecting extensions of connection lines provided at the connecting teeth to the coupling patterns provided on the top PCB.

According to some manufacturing method embodiments, when manufacturing the antenna array using a PCB bottom sheet and flexible or thermoformable top sheet, the method comprises: providing the PCB bottom sheet with ground plane, grounding pads, RF feeds and optional grounding vias, forming dipole antenna elements, coupling patterns and connection lines on the flexible or thermoformable top sheet, partially cutting out antenna feed lines and connection lines from the flexible or thermoformable top sheet, bending antenna feed lines and connection lines with respect to the rest of the flexible or thermoformable top sheet, optionally slipping said antenna feed lines and connection lines through slots in a supporting structure, slipping said antenna feed lines and connection lines though slots in the bottom PCB, and electrically coupling connection lines to grounding pads and electrically coupling antenna feed lines to RF feeds or grounding pads.

According to some manufacturing method embodiments, when manufacturing the antenna array using the flexible bottom sheet and the flexible top sheet, the method comprises: forming a ground plane, antenna feed lines and connection lines on the flexible bottom sheet, forming arms of dipole antenna elements and coupling patterns on the flexible top sheet, partially cutting out antenna feed lines and connection lines from the flexible bottom sheet, bending the partially cut antenna feed lines and connection lines into an angle with respect to the rest of the flexible bottom sheet, slipping the antenna feed lines and connection lines through slots in a supporting structure, slipping the antenna feed lines and connection lines though slots in the flexible top sheet, and electrically coupling connection lines to the coupling pattern on the flexible top sheet and electrically coupling antenna feed lines to arms of first and second dipole antenna elements on the flexible top sheet.

According to some manufacturing method embodiments, when manufacturing the antenna array using the thermoformable bottom sheet the method comprises: forming a ground plane, antenna feed lines and connection lines on the thermoformable bottom sheet, forming arms of dipole antenna elements and coupling patterns on the top sheet, partially cutting out antenna feed lines and connection lines from the thermoformable bottom sheet, warming at least defined areas of the thermoformable bottom sheet and bending the partially cut antenna feed lines and connection lines into an angle with respect to the rest of the thermoformable bottom sheet, optionally slipping the antenna feed lines and connection lines through slots in a supporting structure, slipping the antenna feed lines and connection lines though slots in the top sheet, and electrically coupling connection lines to the coupling pattern on the top sheet and electrically coupling antenna feed lines to arms of dipole antenna elements on the top sheet.

The present invention has the advantage that the TCDA antenna is modular, simple to manufacture, has low profile, and is lightweight and cheap, while the antenna has a wide scanning angle and thus is particularly suitable for intelligent beamforming for example in wireless communication network base stations. With low profile it is meant that height of the antenna height is much less than a quarter of wavelength at the lowest applicable operation frequency.

### BRIEF DESCRIPTION OF THE DRAWINGS

In the following the invention will be described in greater detail, in connection with preferred embodiments, with reference to the attached drawings, in which

FIG. 1 is a first isometric view of a Unit Cell.

FIG. 2 is a second isometric view of a Unit Cell.

FIG. 3a illustrates a first side view of a Unit Cell

FIG. 3b illustrates a second side view of a Unit Cell

FIG. 4 illustrates first faces of two types of dipole array PCBs

FIG. 5 illustrates second faces of two types of dipole array PCBs

FIG. 6a illustrates a top view of a bottom PCB matrix.

FIG. 6b illustrates a top view of a single Unit Cell of a bottom.

FIG. 7 illustrates a top view of a top PCB matrix.

FIG. 8a illustrates an antenna array having 8×8 antenna ports surrounded by dummy Unit Cells.

FIG. 8b shows an enlarged portion of the antenna array of FIG. 8a.

FIG. 9 illustrates a Unit Cell according to a first SSH UC design.

FIG. 10 illustrates a Unit Cell according to a second SSH UC design.

FIG. 11 illustrates a Unit Cell according to a third SSH UC design.

FIGS. 12a and 12b illustrate bottom and top faces of a top sheet according to the first SSH UC design.

FIG. 13a illustrates a top sheet according to the third SSH UC design.

FIG. 13b illustrates a supporting sheet.

FIG. 13c illustrates placing a first supporting sheet.

FIG. 13d illustrates placing a second supporting sheet.

FIG. 13e illustrates cross section of the third SSH UC design.

FIG. 13f illustrates an enlarged portion of design shown in the FIG. 13e

FIG. 14a illustrates a first face of a flexible sheet.

FIG. 14b illustrates a second face of the flexible sheet.

FIG. 15 illustrates a TCDA antenna structure formed by a single flexible sheet

### DETAILED DESCRIPTION

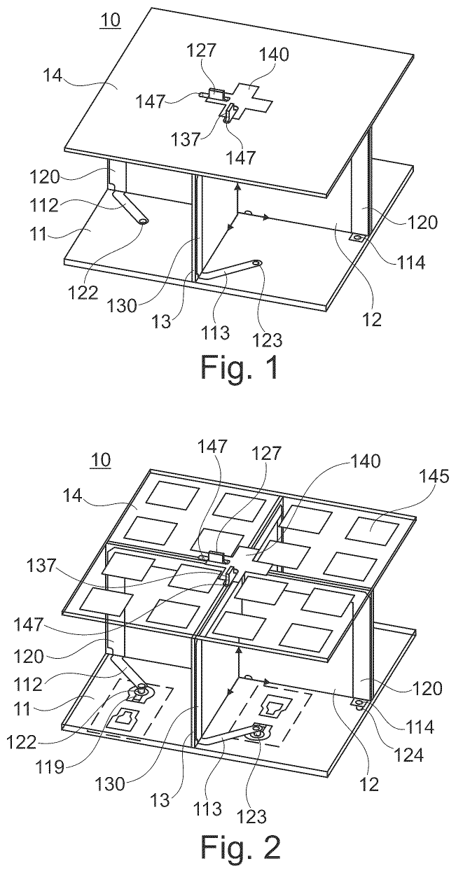

FIGS. 1 and 2 illustrate isometric views of a Unit Cell (UC) 10 of an antenna array composed by a plurality of such UCs to form a two-dimensional array of linear dipoles. FIG. 1 illustrates structure of the UC 10, showing opaque top PCB 14 and bottom PCB 11, and FIG. 2 illustrates the same UC 10 showing transparent top PCB 14 and bottom PCB 11 to reveal more details of the structure. Opaque and transparent PCBs are used for illustration purposes only and have no technical effect.

The UC 10 comprises a bottom PCB 11, two dipole array PCBs 12, 13 crossed with each other and a top PCB 14. The bottom PCB 11 forms a horizontal base layer for the structure and also a ground plane for the antenna array. The two dipole array PCBs 12, 13 have printed thereon two half-dipole antenna elements, also referred in short as half-dipoles 120, 130 on one face (front face) thereof and a connection line 126, 136 on the other face (back face). The two dipole array PCBs 12, 13 are otherwise mutually similar but are provided with dedicated slots 125, 135 that enable assembling them in mutually crossed arrangement. The two dipole array PCBs 12, 13 are placed vertically on top of the horizontal bottom PCB 11. The top PCB 14 is placed horizontally on top of the two dipole array PCBs 12, 13 and it comprises a cross-like coupling pattern 140 on top face thereof for capacitively coupling first and second linear dipoles formed by half-dipoles 120, 130 of dipole array PCBs 12, 13 of adjacent UCs. Dipole coupling considerably increases the array bandwidth towards lower frequencies. The top PCB forms a horizontal top layer for the structure. Metallized patterns are preferably printed on all four types of PCBs 11, 12, 13, 14. The entire structure can be implemented using cheap PCBs that have metallization only on two faces thereof. In the example shown, only the bottom PCB needs to be provided with vias 114, 122, 123. One of the UC's 10 half-dipoles 120, 130 on the first face of the dipole array PCB 12, 13 is coupled to an RF feed 112, 113 on the upper face of the bottom PCB 11. The RF feeding for the RF feed 112, 113 is provided with an RF via 122, 123 through the bottom PCB 11. The other one of the UC's 10 half-dipoles 120, 130 is coupled to ground by a grounding pad 114 and a grounding via 124 provided in the bottom PCB.

The PCB material used for manufacturing each of these PCBs 11, 12, 13, 14 can be cheap plastic with printed metallized patterns on one or two faces of the PCBs. Thus, PCBs are easy and cheap to manufacture. An antenna array formed by PCBs is self-supporting as the dipole array PCBs 12, 13 with top PCB 14 and the bottom PCB 11 forms an impact resisting honeycomb matrix.

Connecting teeth 127, 137 enable coupling the coupling pattern 140 to respective connection lines (not shown), which couple the coupling pattern 140 to the ground provided by the bottom PCB 11. Grounding the coupling pattern 140 improves impedance behaviour thereof and makes the antenna broadband. In some embodiments, the coupling pattern 140 may be left ungrounded, in which case connecting teeth 127, 137 only facilitate mechanical connection between PCBs. Preferably, coupling patterns 140 are in proximity of half-dipoles 120, 130. In each UC, one of two mutually opposite half-dipoles 120, 130 is coupled to RF feeds 112, 113 and the other one of the two mutually opposite half-dipoles 120, 130 is grounded. FIGS. 1 and 2 show grounding of half-dipole 120 of the first dipole array PCB 12 by coupling it to a grounding pad 114 on the bottom PCB 11. Likewise, the other half-dipole of the second dipole array PCB 13 is grounded by coupling it to a grounding pad on the bottom PCB 11 (not shown).

FIG. 2 further shows a frequency selective surface (FSS) pattern 145 printed on the bottom face of the top PCB 14, in this example formed by an array of rectangular metal patches. The bottom face of the top PCB 14 is available for any type of frequency selective surface (FSS) pattern, which can be used for improving antenna matching, scanning and antenna radar cross section (RCS) characteristics. According to some embodiments, the top PCB may be reversed such that the coupling pattern is on the bottom face and the top face may be used for a FSS pattern. Such arrangement, however, makes it somewhat more difficult to make proper contact between connection lines (not shown) and coupling patterns 140.

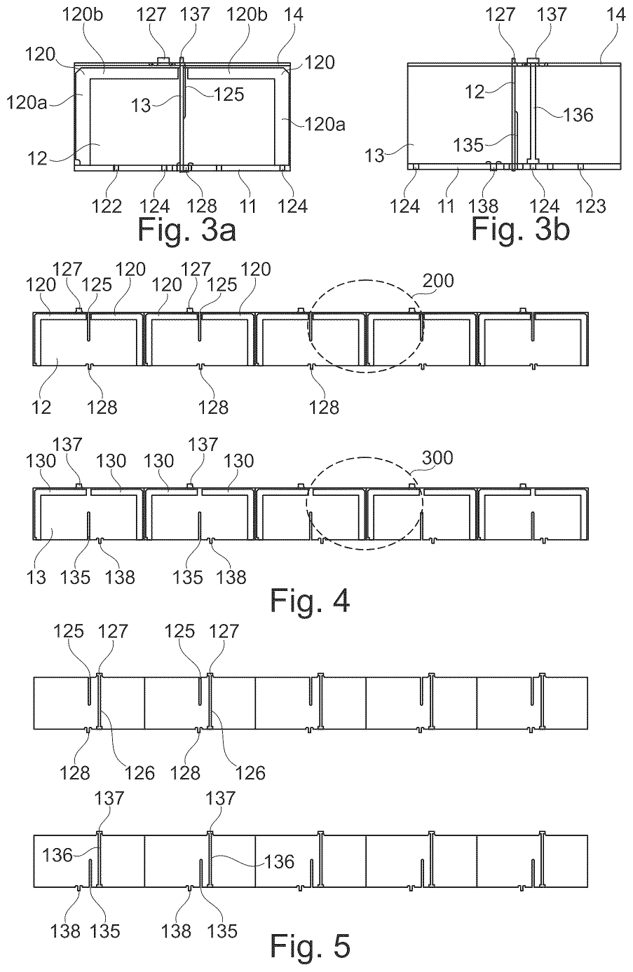

FIGS. 3a and 3b illustrate side views of a single UC 10 of a dipole array.

FIG. 3a shows the UC 10 from direction of a front face of the first dipole array PCB 12 with two half-dipoles 120. Each half-dipole 120 comprises a vertical portion orthogonal to the bottom PCB 11 that is an antenna feed line 120a of the half-dipole 120 and a horizontal portion parallel to the bottom PCB 11 that forms an arm 120b of the half-dipole 120. In this example, the left-hand side antenna feed line 120a is coupled to an RF feed and the right-hand side antenna feed line 120a is coupled to ground. In this design, the connecting tooth 127 is used for mechanically aligning and connecting PCBs together. Mechanical connection between the PCBs can be made also in many other ways. In addition, the connecting tooth 127 is metallized on the back face for providing electrical coupling, as will be explained in connection to FIG. 3b. The front face of the second dipole array PCB 13 has similar two-half-dipoles (not shown). The first dipole array PCB 12 and the second dipole array PCB 13 are placed vertically on the horizontal bottom PCB 11 and each dipole array PCB 12, 13 is supported on the bottom PCB 11 with an aligning tooth 128, 138 fitted in an aligning slot 118 of the bottom PCB 11. The first dipole array PCB 12 and the second dipole array PCB 13 are crossed with each other by means of dedicated slots 125, 135. The top PCB 14 is placed on top of the crossed dipole array PCBs 12, 13. Connecting teeth 127, 137 of the first and second dipole array PCBs 12, 13 are fitted on respective connecting slots 147 in the top PCB 14 to secure the honeycomb structure.

FIG. 3b shows the UC from direction of a back face of the second dipole array PCB 13 that comprises a connection line 136. The upper end of the connection line 136 preferably covers a connecting tooth 137 formed at the top edge of the second dipole array PCB 13. The first dipole array PCB 12 has similar connection line 126 on its back face, covering the connecting tooth 127 at the top edge thereof, as shown in FIG. 5. When connecting slots 147 on the top PCB 14 are fitted on connecting teeth 127, 137 of the first and second dipole array PCBs 12, 13, the respective connection line 126, 136 is connected to the coupling pattern 140 printed on top face of the top PCB 14. The connection line 126, 136 is coupled to ground by a grounding via 124 in the bottom PCB 11. Connecting teeth 127, 137 thus provide mechanical coupling of the dipole array PCBs 12, 13 and the top PCB 14 and enable grounding of the coupling pattern on the top PCB, by the connection lines 126, 136 on the back faces of the dipole array PCBs. As already indicated above, in some embodiments, grounding of the coupling pattern is omitted, in which case connecting teeth 127, 137 are used just for mechanical coupling.

FIG. 4 illustrates first faces, also referred to as front faces of two types of dipole array PCBs forming a dipole array comprising a plurality of UCs arranged into a rectangular grid. Although this example shows five UCs in both dipole array PCBs 12, 13, any number of UCs may be implemented in the antenna array by individually adjusting number of UCs on the first and second dipole array PCBs 12, 13.

A dual polarized or a circular polarized dipole array is formed using two types of dipole array PCBs, a first dipole array PCB 12 for a first polarization and a second dipole array PCB 13 for a second polarization orthogonal to the first polarization. As in the UCs, on these dipole array PCBs, dipole arrays, in other words metal patterns printed thereon, have mutually similar design but the first and second dipole array PCBs 12, 13 have dedicated slots 125, 135 configured for implementing the array crossed dipole construction by fitting together a plurality of mutually parallel first dipole arrays PCBs 12 and a plurality of mutually parallel second dipole arrays PCBs 13. Since both dipole array PCBs comprise an array of plurality of similar UC portions, distance between each two parallel PCBs is equal to one UC distance.

On front face of the dipole array PCBs in FIG. 4 is shown the dipole pattern comprising two half-dipoles 120 per UC. The dipole pattern may be manufactured using any suitable manufacturing method known in the art. For example, the dipole pattern may be etched on the front face of the PCBs, grown using additive manufacturing, printed using conductive inks, to mention a few. One “T”-shaped dipole antenna element is formed by two half-dipoles printed on two adjacent UCs. Exemplary first dipole 200 and first dipole 300 formed by adjacent half-dipoles of two adjacent UCs are encircled in FIG. 4. Connecting teeth 127, 137 associated with the connection lines (not shown) are formed on the top edge of the dipole array PCBs 12, 13 and aligning teeth 128, 138 for mechanically supporting the dipole array PCBs 12, 13 on the bottom PCB (not shown) are formed on the bottom edge of the dipole array PCBs 12, 13.

FIG. 5 illustrates second faces, also referred to as back faces, of the first and second dipole array PCBs 12, 13. Like the front face of the PCBs, conductive patterns on the back faces may be manufactured by any suitable manufacturing method. For example, the pattern may be etched, grown using additive manufacturing, printed using conductive inks and so on. On back faces of the first 12 and second dipole array PCBs 13 there are connection lines 126, 136 each of which is configured to be attached with a respective grounding pad (not shown) on the upper face of the bottom PCB 11 and with the respective coupling cross on the top PCB 14. Alternatively, faces of the bottom PCB 11 can be reversed such that the PCB ground is on the top face of the bottom PCB 11. In this case, connection lines 126, 136 are configured to be attached directly to bottom PCB ground and no separate grounding vias are needed. Upper end of each connection line 126, 136 preferably covers the connecting tooth 127, 137 at the top edge of the respective first or second dipole array PCB 12, 13 for connecting the connection line 126, 136 with the coupling pattern 140 in the top PCB 14.

The first and second dipole array PCBs 12, 13 are mechanically designed to have aligning teeth 128, 138 and connecting teeth 127, 137. Aligning teeth 128, 138 are arranged at one UC distance intervals at the bottom edge of the first and second dipole array PCBs 12, 13. Connecting teeth 127, 137 are arranged at one UC distance intervals at the top edge of the first and second dipole array PCBs 12, 13. Aligning teeth 128, 138 are configured to fit into aligning holes 118 in the bottom PCB 11, the aligning holes 118 going through the bottom PCB 11, and connecting teeth 127, 137, the connecting holes going through the top PCB 14, which comprises connection pads (not shown) for electrically coupling the connection line 126, 136 with the coupling pattern 140.

According to some embodiments, a single polarized antenna array is implemented. Single polarized antenna array is achieved by having half-dipoles only in one direction. For example, referring to FIGS. 4 and 5, single polarized antenna array formed by a plurality of dipole antennas 200 is achieved when half-dipole elements 120 are implemented only on the first dipole array PCB 12, but not on the second dipole array PCB 13. In such arrangement, only the first dipole array PCB 12 is preferably provided with connection lines 126 for connecting coupling patterns of UCs to ground. In this embodiment, the second “dipole array PCBs” in this case merely act as mechanical support for the structure.

According to some embodiments, a circular polarized antenna array is implemented. Circular polarized antenna array is achieved when orthogonal antenna elements of the dual polarized antenna array structure as shown in the FIGS. 4 and 5 are fed in mutually quadrature phases. In other words, dipole antennas 200 of the first dipole array PCB 12 are fed in quadrature phase in comparison to dipole antennas 300 of the second dipole array PCB 13.

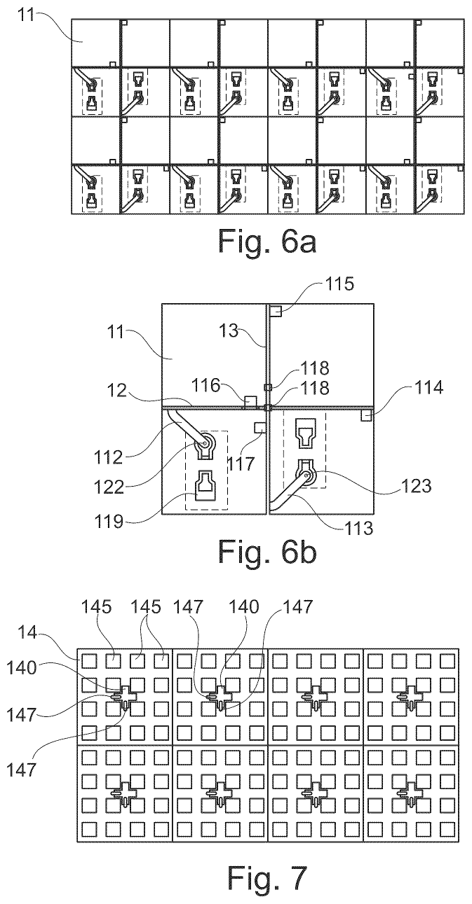

FIGS. 6a and 6b illustrate a top view of the bottom PCB 11 with first and second dipole arrays 12, 13 installed on it. FIG. 6a shows a 4×2 matrix for eight UCs. FIG. 6b shows an enlarged view of a portion of the bottom PCB 11 corresponding to a single UC. The bottom PCB 11 forms a ground plane for the antenna array. In the shown design each UC has a first RF feed 112 on top face of the bottom PCB 11 for feeding first half-dipole 120 on the respective second dipole array PCB 12 and second RF feed 113 for feeding second dipole elements 130 on the respective first dipole array PCB 13. Additionally, there are four grounding pads. A first dipole grounding pad 114 provides grounding for a first half-dipole and a second dipole grounding pad 115 provides grounding for a second half-dipole. A first coupling grounding pad 116 and a second coupling grounding pad 117 provide ground to coupling patterns 140 on top PCB 14 via the connection lines 126, 136. Coupling patterns 140 of the top PCB are connected to bottom PCB 11 via the connection lines 126, 136 printed on second faces of the two dipole array PCBs 12, 13.

In this design, there are six via connections in the bottom PCB 11 from its top face to bottom face. A plurality of vias 124 in the bottom PCB 11 can be seen in the FIG. 2. Four grounding vias 124 connect grounding pads 114, 115, 116, 117 to ground plane on back face (bottom face) of the bottom PCB 11 and two RF feed vias 122, 123 connect to the RF feeds 112, 113. The first bottom PCB 11 configuration facilitates an easy layout for RF-connectors for measuring purposes. Exemplary RF-connector layouts 119 at back of the bottom PCB 11 are schematically illustrated in FIGS. 2, 6a and 6b.

According to some embodiments, order of bottom PCB's 11 top and bottom faces can be reversed. In this case separate grounding pads associated with grounding pads 114, 115 are not needed, because the dipoles can be directly connected to the metallized ground plane and the half-dipoles can be fed across first RF feed 112 and first ground pair and second RF feed 113 and second ground pair.

FIG. 7 illustrates a top view of the top PCB 14 arranged as a 4×2 matrix for eight UCs. A cross-shaped coupling pattern 140 is provided at the center of each UC, to which the connection lines are connected by means inserting the connecting teeth 127, 137 at the top edges of the first and second dipole array PCBs 12, 13 through connecting slots 147.

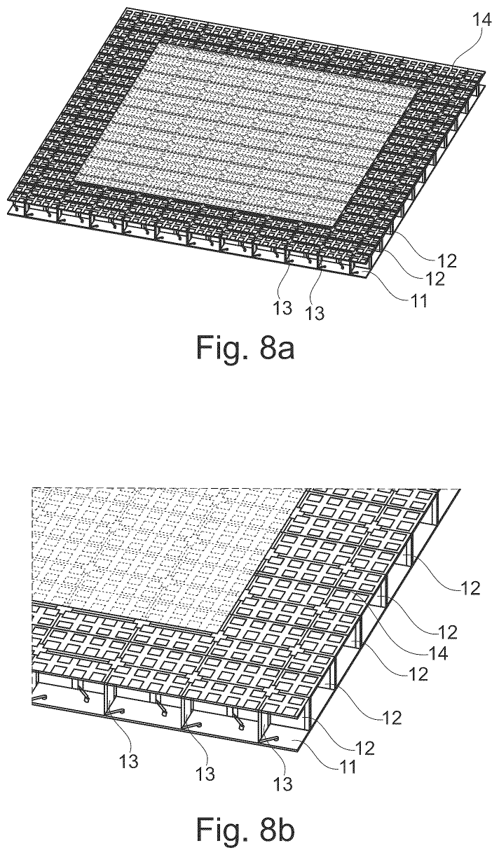

FIGS. 8a and 8b illustrate an antenna array having 8×8 antenna ports surrounded by 1.5 dummy UCs, thus forming a 11×11 UC array. The FIG. 8b shows enlarged view of a portion of the antenna array shown in the FIG. 8a. The 8×8 active dipole antennas fed by antenna ports are shown as highlighted in the middle of the antenna array. This UC structure is scalable, since the same UC structure can be configured into any size antenna matrix by copying the same UC structure on a desired array of m×n UCs, which is composed of a plurality of first and second linear dipole arrays.

In the above-described UC based antenna array, antenna size is set based on upper operation frequency fₕ. As known in antenna array design dipole element distance to next dipole is half wavelength, i.e.

$$d = c / {f}_{h} / 2 \qquad [ Equation 1 ]$$

where d=array element distance, c=speed of light, fₕ=highest operation frequency.

For frequencies higher than fₕ, grating lobes start to merge when antenna beam is scanned. For an exemplary, a prototype antenna array had d=20 mm and fₕ=7.5 GHZ.

Dipole array height (without coupling and aligning teeth) was 9.22 mm and total antenna height hₐ from bottom PCB 11 bottom surface to top PCB 14 top surface was 10.0 mm i.e. hₐ=λ(fₕ)/4 with 2.5:1 bandwidth.

Antenna gain is defined as:

$$G = {4}^{*} {π}^{*} η * A / λ \hat{} 2 \qquad [ Equation 2 ]$$

where G=antenna gain, η=efficiency, A=antenna area and λ=wavelength

This means that the gain at fₕ drops by 6 dB at fₕ/2. As an example, a m×n element array with half wavelength element distance fₕ, A=16*λ\hat{ }2 and

$${G}_{dB} ( {f}_{h} ) = {10}^{*} log ( {π}^{*} {η}^{*} {m}^{*} n ) = 23 dBi + {10}^{*} log ( η ) , \\ when m = n = 8 \qquad [ Equation 3 ]$$

Unlike a multilayer, stacked planar antenna array, the presented TCDA structure is mostly filled with air, whilst substrates are needed just for supporting structure for the metal parts. Consequently, expensive substrates, even the PCB used in the first embodiment may be replaced by low-cost plastics, such as polyethylene membrane. Simulations show that metallization can be made by printing. Conductivity of printed Ag-paste may be just 1/100th of bulk copper but still produces an acceptable TCDA antenna. This is because of the relatively low operation frequency, and also because coupled dipoles do not have strong in-band resonances, which would be sensitive to the metal/substrate losses.

Thus, the same UC array principle that enables forming the antenna array of FIG. 8 can also be implemented by printing metal patterns forming elements of the antenna array, such as the half-dipoles and the coupling pattern on a flexible sheet material instead of PCB. In the following, we refer to the embodiments using flexible sheet material as “single-sheet UC” designs, in short SSH UC.

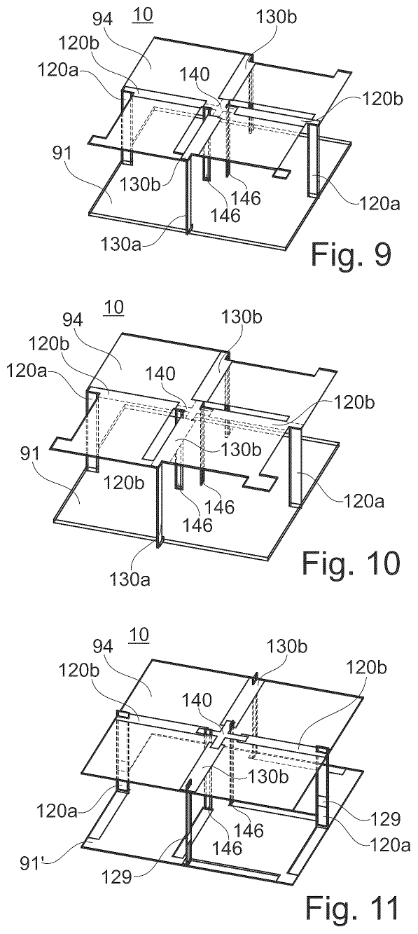

FIG. 9 illustrates an UC 10 according to a first SSH UC design. The whole dipole antenna array structure above the bottom sheet 91 is printed on top face of a single plastic sheet with 2-sided print. Connection lines to bottom sheet 91 are cut out from the top sheet 94 on three sides and bent down preferably 90 degrees to form a 3D structure. The top sheet 94 is preferably made of thin, flexible plastic sheet, such as polyethylene, polyimide or polycarbonate membrane. In practice, almost any type of plastic formed as a thin membrane is applicable. Metal patterns forming two half-dipoles are preferably printed on two opposite faces of the top sheet 94. Like in the first embodiment, each half-dipole 120, 130 comprises an antenna feed line 120a, 130a that is orthogonal to the bottom sheet 91 and an arm 120b, 130b that is parallel with the bottom sheet 91. The bottom sheet 91 forms a ground plane for dipole antennas. In this embodiment, the bottom sheet 91 may be a rigid sheet, such as a PCB. Each half-dipole 120, 130 is formed the antenna feed line 120a, 130a of the printed pattern on the cut and bent portion of the top sheet 94 and the arm 120b, 130b on the non-bent portion of the top sheet 94. One of two adjacent antenna feed lines 120a, 130b of two adjacent UCs 10 is coupled to a radio frequency (RF) feed and other is a ground feed coupled to ground provided at the bottom sheet 91. Adjacent antenna feed lines 120a, 130a of adjacent UCs have a small gap between them to avoid short-circuit between adjacent antenna feed lines (RF feed line and the ground feed line). In this first SSH UC design, the coupling pattern 140 is printed on the bottom face of the top sheet 94 and coupled by connection lines 146 to the ground provided at the bottom sheet 91. To enable bending connection lines 146 down to the bottom sheet 91, these are provided on portions of the top sheet 94 that are cut out from the top sheet 94 on three sides thereof and bent down preferably 90 degrees. As in the first embodiment, two half-dipoles of two adjacent UCs 10 form a dipole antenna, with antenna feed lines formed by the two adjacent antenna feed lines 120a, 130a.

Arms 120b, 130b are on the opposite face of the top sheet 94 in comparison to the coupling pattern 140. Arms 120b, 130b are capacitively coupled to the coupling pattern 140 over a small gap formed by the think plastic layer formed between the two metal layers printed on the top sheet's 94 opposite faces. For improving coupling between the arm 120b, 130b and the coupling pattern 140, arms of the cross-shaped coupling pattern 140 preferably extend for a short distance under outer ends of the respective arms 120b, 130b on the opposite face of the top sheet 94.

Like in the first embodiment, a plurality of UCs 10 is arranged in a rectangular grid to form the antenna array. In this case, the antenna array can be implemented by a single top sheet 94 that includes all UCs 10 needed for the wanted antenna array and a bottom sheet 91, which may be implemented as a PCB or as a plastic board that is essentially non-flexible, thus forming a mechanical supporting base for the antenna array.

FIG. 10 illustrates an UC according to a second SSH UC design. This can be considered as a variation of the first SSH UC design, thus the same description applies, except what is specifically provided herein. In this variation, half-dipoles at opposite sides of the UC 10 are printed on opposite faces of the top sheet 94 as to avoid accidental shorting of antenna feed lines 120a, 130a over the narrow gap between adjacent antenna feed lines 120a, 130a of adjacent UCs 10 and thus to avoid shorting between the RF feed and ground feed. In this arrangement, the two arms of the cross-shaped coupling pattern 140 extend towards arms 120b, 130b. Two arms 120b, 130b are on the same face of the top sheet 94 and a small gap is provided between the arms 120b, 130b and the coupling pattern 140. Two arms 120b, 130b are on the opposite face of the top sheet 94 and are coupled to the coupling pattern 140 by a small gap formed by the top sheet 94 between the two metal layers on the top sheet's 94 opposite faces. For improving coupling between arms 120b, 130b and the coupling pattern 140, the coupling pattern 140 preferably extend for a short distance under the respective arms 120b, 130b on the opposite face of the top sheet 94.

FIG. 11 illustrates a UC 10 according to a third SSH UC design. This embodiment has a one-sided printed top sheet 94 that comprises arms 120b, 130b of half-dipoles and the coupling pattern 140. Arms 120b, 130b are separated from the coupling pattern 140 with a small gap. In an alternative implementation, arms 120b, 130b may be printed on two faces of the top sheet 94 as in the second SSH UC design. In the third SSH UC design, also the bottom sheet 91′ is made of a thin, cheap plastic sheep such as polyethylene, polyimide or polycarbonate membrane.

In the third SSH UC design, antenna feed lines 120a, 130a and connection lines 146 are printed on the bottom sheet 91′ and cut out from the bottom sheet 91′ on three sides thereof and bent up 90 degrees to connect the two horizontal layers formed by the bottom sheet 91′ and the top sheet 94.

The bottom sheet 91′ is preferably manufactured using similar thin, flexible plastic sheet as the top sheet 94. In such case, patterns for both the bottom sheet 91′ and the top sheet 94 may be printed on a single plastic sheet. Thus, the bottom sheet 91′ can be considered as an extension of the top sheet 94, wrapped around 180 degrees at one or more edges to form a 3D antenna array structure.

In all three SSH UC designs, metal patches 129 may be printed on the bent portions comprising the antenna feed lines 120a, 130a, on the opposite face thereof, to improve wide band matching. An example of such metal patches 129 is shown in the FIG. 11.

Although not specifically shown, antenna feeding in all SSH UC designs uses the same feeding principle as discussed in connection to the PCB embodiment explained above. Antenna feed lines 120a, 130a of an UC in all SSH UC designs discussed herein are fed such that two antenna feed lines, one for each of the two different polarity dipoles are fed with RF feeds and two antenna feed lines, one for each of the two different polarity dipoles, is coupled to ground.

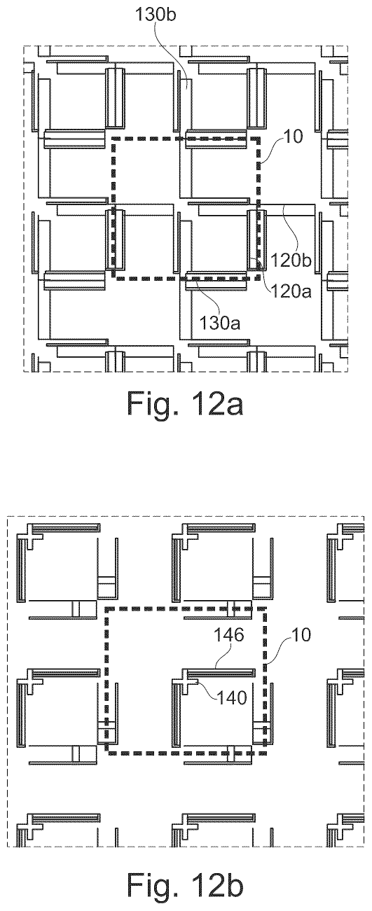

FIGS. 12a and 12b illustrate top sheet 94 according to the first SSH UC design. FIG. 12a shows the top surface of the top sheet 94 before bending antenna feed lines 120a, 130a and connection lines 146, preferably by 90 degrees. One UC is marked with dotted line. This UC pattern is repeated over the entire top sheet 94. Dipole antennas with first polarization are formed by half-diploes of adjacent UCs 10 in one direction and dipole antennas with second polarization are formed by half-dipoles of adjacent UCs 10 in the other direction. Thus, the antenna array shown in these figures is either dual polarized or circular polarized, depending on whether UCs are fed in same phase or in quadrature phase. Antenna feed line and connection lines 146 for grounding the coupling element 140 are cut out of the sheet for example by laser or by hole punching from three sides for 90-degree bending to bottom sheet. Metal patches 129 may be printed behind antenna feed lines 120a, 130a to improve wide band matching.

FIG. 12b shows the bottom surface of the top sheet 94 before bending antenna feed lines 120a, 130a and connection lines 146. One UC is marked with dotted line. Coupling pattern 140 is provided with two connection lines 146. These connection lines 146 are configured to be bent preferably to 90 degrees, i.e. orthogonal to the top sheet 94 and coupled to ground in the bottom sheet.

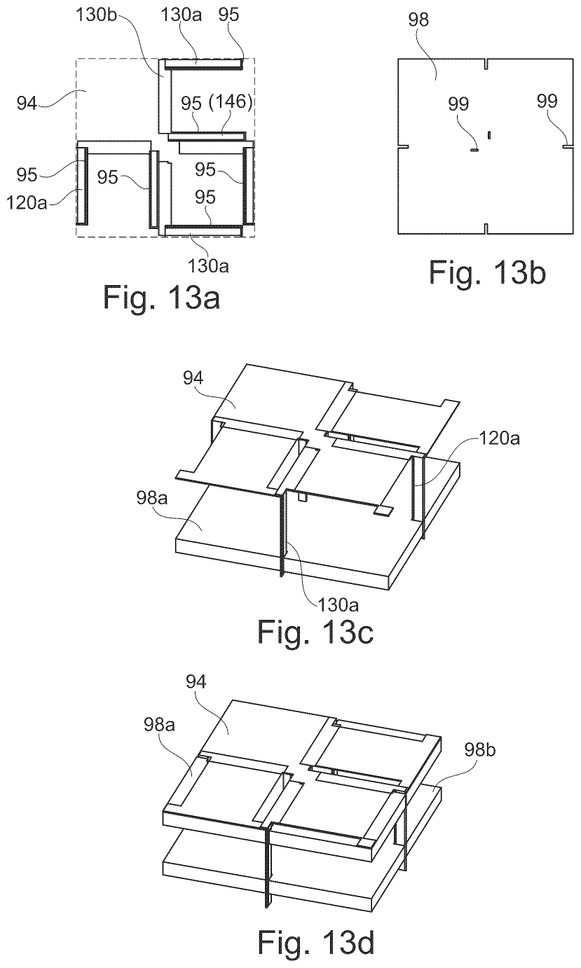

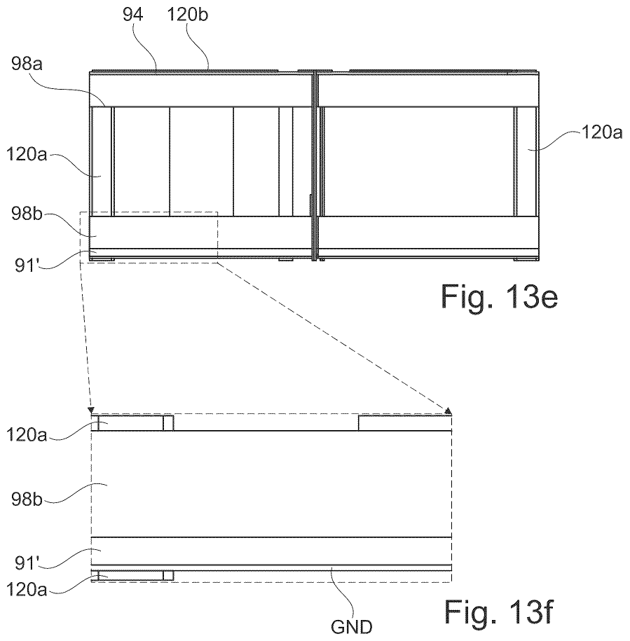

According to some embodiments, the antenna array disclosed in FIGS. 9, 10 and 11 is not self-supporting, but an additional support structure is needed. An exemplary antenna folding procedure for an antenna array based on the first SSH UC design is shown in FIGS. 13a to 13f. The same method is applicable to all SSH UC designs.

According to some embodiments, the antenna array disclosed in FIGS. 9, 10 and 11 is self-supporting. For example, the antenna array may be manufactured out of 0.3 to 0.5 mm thermoformable plastic sheet, such as polycarbonate sheet. By bending such thermoformable plastic sheet in desired shape using thermoforming techniques, the sheet structure becomes self-supporting in operating temperature range.

FIG. 13a illustrates a portion of the top sheet 94 corresponding to one UC. The top sheet 94 has been cut 95 to enable bending of connection lines (on the opposite surface of the top sheet 94) and antenna feed lines 120a, 130a for connecting these to the bottom sheet 91.

FIG. 13b illustrates a supporting sheet 98. The supporting sheet 98 is provided with slots 99 to guide bent connection lines and antenna feed lines to vertical position, orthogonal to the top sheet 94. According to some embodiments, the supporting sheet is manufactured from suitable structural foam, for example polymethacrylimide (PMI) foam marketed with name Rohacell®. Alternatively, a 3D support structure may be manufactured by means of 3D printing.

FIG. 13c illustrates slipping the bent connection lines and antenna feed lines 120a, 130a of the top sheet 94 through slots 99 in a first supporting sheet 98a and the horizontal part of the top sheet 94 is pressed against the first supporting sheet 98a.

FIG. 13d illustrates further slipping the bent connection lines and antenna feed lines 120a of the top sheet through slots 99 in a second supporting sheet 98b. A spacer (not shown) is placed between the first and second supporting sheets to give the antenna the wanted height.

Finally, a bottom sheet 91 is pressed against the bottom face of the second supporting sheet 98b and connection lines 126, 136 and antenna feed lines 120a, 130a are attached to the bottom sheet 91 to form electrical connections.

FIG. 13e illustrates side view of the finalized antenna array structure. FIG. 13f illustrates an enlarged portion of the finalized antenna array structure shown in FIG. 13e. Spacers (97) maintain the correct distance of the top sheet 94 and the bottom sheet 91. Connection lines 146 and antenna feed lines 120a, 130a extend all the way from the top sheet 94 through both supporting sheets 98a, 98b and the bottom sheet 91.

There are several options to connect antenna feed lines reliably to the bottom sheet 91. Accidental short circuiting of parallel adjacent antenna feed lines (RF feed line and ground feed line) over the narrow gap in between these feed lines should be avoided for SSH type 1. When adjacent antenna feed lines are on opposite faces of the flex, as in SSH type 2, antenna feed lines do not have imminent accidental shorting danger.

It is left to the manufacturer how many unit cells can be processed at one time with the described manufacturing method. Dedicated process automation, 3D-printing methods etc. are necessary for proper line alignment and reliable line connections to back board for manufacturing large antenna arrays in single process. Alternatively manufacturing smaller sub-modules may be considered.

It is left to the manufacturer how many unit cells can be processed at one time with this method. Dedicated process automation, 3D-printing methods etc. are necessary for proper line alignment and reliable line connections to back board for manufacturing large antenna arrays in single process. Alternatively manufacturing smaller sub-modules should be considered.

In all above-described embodiments, a frequency selective surface (FSS) pattern 145 may be printed on the bottom face of the top sheet 94, 94′.

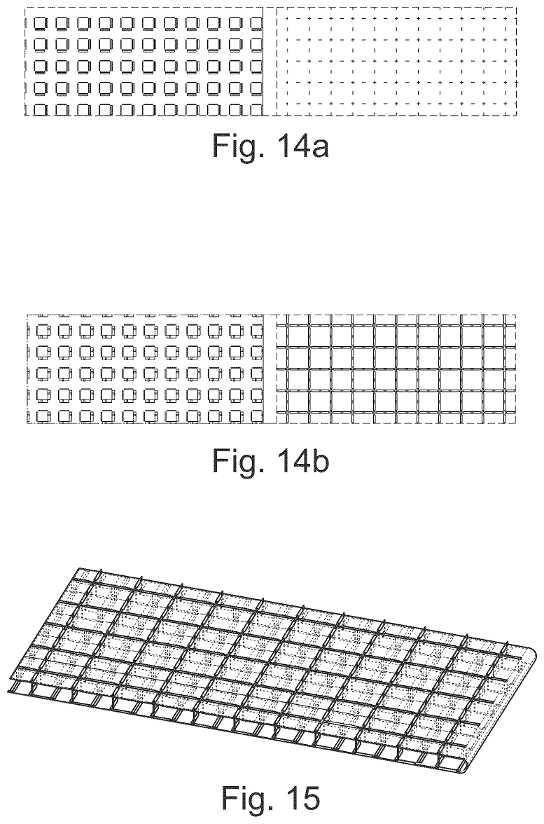

FIGS. 14a, 14b and 15 illustrate an exemplary implementation of an antenna array applying the third SSH UC design shown in FIG. 9. With this implementation principle, the entire antenna array can be manufactured on a single, printed flexible sheet. Alternatively, the antenna array may be manufactured by a few sub-arrays that use the same construction as illustrated herein.

FIG. 14a shows a first face of a flexible sheet 90 and FIG. 14b shows a second face of the same flexible sheet. The same flexible sheet 90 comprises both the bottom sheet 91′ and the top sheet 94. Metallized ground layer, connection lines 146 and antenna feed lines 120a, 130a are printed on left hand side of the first face of the flexible sheet 90, with cuts for coupling connection lines 146 and antenna feed lines 120a, 130a. In this example, antenna feed lines 120a, 130a printed on the first face of the flexible sheet are provided with optional metal patches 129 printed on second face of the flexible sheet to improve wide band matching. Cuts are better visible on the left-hand side of the second face shown in the FIG. 14b. In FIG. 14b, on the right-hand side, coupling patterns 140 and arms 120b, 130b are shown on the second face of the flexible sheet 90, and the right-hand side is provided with slots 99 for connection lines 146 with the coupling pattern 140 and antenna feed lines 120a, 130a to arms 120b, 130b. A bend portion 143 is provided between the right-hand side and the left-hand side that enables bending the right-hand side and the left-hand side such that these become superimposed.

FIG. 15 illustrates the final antenna structure using the two-sided flexible sheet illustrated in FIGS. 14a and 14b. The flexible sheet 90 is bent 180 degrees so that the left-hand side and the right-hand side shown in FIGS. 14a and 14b are superimposed. Connection lines 146 and antenna feed lines 120a, 130a are bent upwards preferably 90 degrees and brought through the respective slots 99 for coupling these to the coupling pattern 140 and arms 120b, 130b.

As understood by the skilled person, the antenna array structure shown in the FIG. 15 may be supported by a supporting structure, such as supporting sheets made of supporting foam as shown in the FIGS. 13b to 13e or a 3D-printed support structure.

According to some embodiments, a single polarized antenna array is implemented using any one of the above-described mechanical structures by implementing half-dipoles along just one direction.

According to some embodiments, a circular polarized antenna array is implemented. Circular polarized antenna array can be implemented by feeding orthogonal antenna elements of the dual polarized antenna array structure according to any one of the above-described mechanical antenna array structures in quadrature phases.

It is apparent to a person skilled in the art that as technology advanced, the basic idea of the invention can be implemented in various ways. The invention and its embodiments are therefore not restricted to the above examples, but they may vary within the scope of the claims.

1. A polarized tightly coupled dipole antenna array comprising a plurality of rectangular unit cells (UC), each UC comprising:
a bottom sheet comprising a ground plane, and
two first half-dipole antenna elements, each first half-dipole antenna element comprising:
an arm parallel to the bottom sheet and spaced from the bottom sheet, and
an antenna feed line extending to the bottom sheet,
wherein antenna feed lines of the two first half-dipole antenna elements extend between the bottom sheet and the respective arm in proximity of two opposite sides of the UC and arms of the two first half-dipole antenna elements fed by said antenna feed lines extend from two opposite sides of the UC towards each other, and wherein each first dipole antenna element of the antenna array with a first polarity are formed by two first half-dipole antenna elements of adjacent UCs,
wherein each UC comprises:
a top sheet parallel to the bottom sheet, the top sheet being made of dielectric material and comprising a coupling pattern at the center of the UC, wherein the coupling pattern is on either face of the top sheet, wherein the coupling pattern is configured to capacitively couple two dipole antenna elements,
wherein the coupling pattern is grounded by a connection line extending between the top sheet and ground provided at the bottom sheet.

2. A polarized tightly coupled dipole antenna array according to claim 1, wherein each UC further comprises:
two second half-dipole antenna elements, each second half-dipole antenna element comprising:
an arm parallel to the bottom sheet and spaced from the bottom sheet, and
an antenna feed line extending to the bottom sheet,
wherein arms of the first half-dipole antenna elements are orthogonal to arms of the second half-dipole antenna elements, and wherein antenna feed lines of the two second half-dipole antenna elements extend between the bottom sheet and the respective arm in proximity of two opposite sides of the UC and arms of the two second half-dipole antenna elements fed by said antenna feed lines extend from two opposite sides of the UC towards each other,
and wherein each second dipole antenna element of the antenna array with a second polarity is formed by two second half-dipole antenna element of adjacent UCs,
and wherein the coupling pattern at the center of each UC is configured to capacitively couple two first dipole antenna elements and two second dipole antenna elements, and wherein the coupling pattern is grounded by at least two connection lines extending between the top sheet and ground provided at the bottom sheet.

3. The antenna array according to claim 1, wherein said connection line is connected to the coupling pattern in proximity of the arm of half-dipole connected to a radio frequency (RF) feed.

4. The antenna array according to claim 1, wherein all half-dipoles, antenna feed lines, coupling patterns and connection lines are metallization printed on sheets of dielectric material.

5. The antenna array according to claim 4, wherein the metallization is conductive ink.

6. The antenna array according to claim 1, wherein the antenna array is implemented with a plurality of printed circuit boards (PCBs), wherein
the bottom sheet is a PCB; and
the top sheet is a PCB;
a plurality of first dipole antenna elements of the plurality of UCs is disposed on a first face of one or more first dipole array PCBs and a plurality of connection lines are disposed on the second face of the one or more first dipole array PCBs; and
a plurality of second dipole array PCBs with no dipole antenna elements;
wherein the one or more of first dipole array PCBs and the one or more second dipole array PCBs are provided with dedicated slots for assembling the one or more of first dipole array PCBs and the one or more second dipole array PCBs in mutually crossed arrangement.

7. The antenna array according to claim 6, wherein each portion of the first and the second dipole array PCB corresponding to an UC comprises an aligning tooth and a connecting tooth,
wherein each connecting tooth is configured to be installed within a respective connecting slot in the top sheet, and
wherein each aligning tooth is configured to be installed within a respective aligning slot in the bottom sheet.

8. The antenna array according to claim 7, wherein each connecting tooth is arranged on extension of a respective connection line, and wherein the extension of the connection line is configured to be connected to the coupling pattern in the top sheet.

9. The antenna array according to claim 1, wherein
the bottom sheet is a printed circuit board (PCB); and
antenna feed lines and arms of dipole antenna elements, connection lines and coupling patterns are disposed on two faces of a flexible or thermoformable top sheet,
wherein antenna feed lines of the dipole antenna elements and connecting lines are partially cut out from the top sheet, bent towards the bottom sheet and electrically coupled to respective RF feeds or ground provided at the bottom sheet.

10. The antenna array according to claim 1, wherein
connection lines, and antenna feed lines of the dipole antenna elements are on a flexible or thermoformable bottom sheet; and
arms of the dipole antenna elements, and coupling patterns are on a flexible or thermoformable top sheet,
wherein antenna feed lines of the dipole antenna elements and connection lines are partially cut out from the flexible or thermoformable bottom sheet, bent towards the top sheet and electrically coupled to respective arms and coupling pattern on the top sheet.

11. The antenna array according to claim 10, wherein the flexible or thermoformable bottom sheet and the flexible or thermoformable top sheet are provided as two portions of a single flexible or thermoformable sheet, and a bend portion is provided between the two portions for bending the flexible or thermoformable bottom sheet and the flexible or thermoformable top sheet parallel to each other.

12. The antenna array according to claim 9, wherein at least one supporting sheet is sandwiched between the bottom sheet and the top sheet, wherein the at least one supporting sheet is parallel to the top sheet and to the bottom sheet and wherein the at least one supporting sheet is provided with slots for passing connection lines and antenna feed lines through the at least one supporting sheet.

13. The antenna array according to claim 12, wherein two supporting sheets are sandwiched between the bottom sheet and the top sheet and a spacer is provided between the two supporting sheets.

14. The antenna array according to claim 9, wherein a 3D printed supporting structure is sandwiched between the top sheet and the bottom sheet, the supporting structure having slots for connection lines and antenna feed lines.

15. The antenna array according to claim 9, wherein the flexible top sheet is a polyethylene, polyimide or polycarbonate membrane.

16. A method of manufacturing an antenna comprising:
a printed circuit board (PCB) bottom sheet;
a PCB top sheet;
a plurality of first dipole antenna elements of a plurality of unit cells (UCs) disposed on a first face of one or more first dipole array PCBs and a plurality of connection lines disposed on a second face of the one or more first dipole array PCBs; and
a plurality of second dipole antenna elements of the plurality of UCs disposed on a first face of one or more second dipole array PCBs and a plurality of connection lines disposed on a second face of the one or more second dipole array PCBs or a plurality of second dipole array PCBs with no dipole antenna elements;
the method comprising:
assembling the one or more first dipole array PCBs and the one or more second dipole array PCBs arranged into a rectangular grid on top of the bottom PCB, wherein locations of the first and second dipole array PCBs on the bottom PCB are determined by fitting alignment teeth at the bottom edge of the first and second dipole array PCBs into alignment slots on the bottom PCB;
electrically connecting antenna feed lines and connection lines on the dipole array PCBs with the bottom PCB;
assembling a top PCB on top of the rectangular grid, wherein location of the top PCB on the rectangular grid is determined by fitting connecting teeth at the top edge of the first and second dipole array PCBs into connecting slots provided in the top PCB; and
electrically connecting extensions of connection lines provided at the connecting teeth to the coupling patterns provided on the top PCB.

17. A method of manufacturing the antenna array of claim 9, the method further comprising:
providing the PCB bottom sheet with ground plane, grounding pads, RF feeds and optional grounding vias;
forming dipole antenna elements, coupling patterns and connection lines on the flexible or thermoformable top sheet;
partially cutting out antenna feed lines and connection lines from the flexible or thermoformable top sheet;
bending antenna feed lines and connection lines with respect to the rest of the flexible or thermoformable top sheet;
optionally slipping said antenna feed lines and connection lines through slots in a supporting structure;
slipping said antenna feed lines and connection lines though slots in the bottom PCB; and
electrically coupling connection lines to grounding pads and electrically coupling antenna feed lines to RF feeds or grounding pads.

18. A method of manufacturing the antenna array of claim 10 when having the flexible bottom sheet and the flexible top sheet, the method comprising:
forming a ground plane, antenna feed lines and connection lines on the flexible bottom sheet;
forming arms of dipole antenna elements and coupling patterns on the flexible top sheet;
partially cutting out antenna feed lines and connection lines from the flexible bottom sheet;
bending the partially cut antenna feed lines and connection lines into an angle with respect to the rest of the flexible bottom sheet;
slipping the antenna feed lines and connection lines through slots in a supporting structure;
slipping the antenna feed lines and connection lines though slots in the flexible top sheet; and
electrically coupling connection lines to the coupling pattern on the flexible top sheet and electrically coupling antenna feed lines to arms of first and second dipole antenna elements on the flexible top sheet.

19. A method of manufacturing the antenna array of claim 10 when having the thermoformable bottom sheet, the method comprising:
forming a ground plane, antenna feed lines and connection lines on the thermoformable bottom sheet;
forming arms of dipole antenna elements and coupling patterns on the top sheet;
partially cutting out antenna feed lines and connection lines from the thermoformable bottom sheet;
warming at least defined areas of the thermoformable bottom sheet and bending the partially cut antenna feed lines and connection lines into an angle with respect to the rest of the thermoformable bottom sheet;
optionally slipping the antenna feed lines and connection lines through slots in a supporting structure;
slipping the antenna feed lines and connection lines though slots in the top sheet; and
electrically coupling connection lines to the coupling pattern on the top sheet and electrically coupling antenna feed lines to arms of dipole antenna elements on the top sheet.

20. The antenna array according to claim 2, wherein the antenna array is implemented with a plurality of printed circuit boards (PCBs), wherein
the bottom sheet is a PCB;
the top sheet is a PCB;
the plurality of first dipole antenna elements of the plurality of UC's is disposed on a first face of one or more first dipole array PCB's and a plurality of connection lines are disposed on the second face of the one or more first dipole array PCBs;
a plurality of second dipole antenna elements of the plurality of UC's is disposed on a first face of one or more second dipole array PCBs and a plurality of connection lines are disposed on the second face of the one or more second dipole array PCBs; and
wherein the one or more of first dipole array PCBs and the one or more second dipole array PCBs are provided with dedicated slots for assembling the one or more first dipole array PCBs and the one or more second dipole array PCBs in a mutually crossed arrangement.
